(19) United States
(12) Patent Application Publication
(10) Pub. No.: US 2024/0117531 A1
(43) Pub. Date: Apr. 11, 2024

(54) MICROWAVE HEATING UNIT AND METHOD FOR PRODUCING CARBON FIBER USING THE SAME

(71) Applicant: TEIJIN LIMITED, Osaka-shi, Osaka (JP)

(72) Inventors: Yoshinori SUZUKI, Osaka-shi (JP); Hiroaki ZUSHI, Osaka-shi (JP); Jun-ichi SUGIYAMA, Tsukuba-shi (JP)

(73) Assignee: TEIJIN LIMITED, Osaka-shi, Osaka (JP)

(21) Appl. No.: 18/275,326

(22) PCT Filed: Feb. 1, 2022
(86) PCT No.: PCT/JP2022/003831

§ 371 Date: Aug. 1, 2023

(30) Foreign Application Priority Data
Feb. 2, 2021 (JP) 2021-015373

(51) Int. Cl. D01F 9/32; F27D 11/12

(52) U.S. Cl. CPC D01F 9/32; F27D 11/12; D10B 2101/12; F27D 2003/0057

(57) ABSTRACT

The present invention provides a microwave heating unit formed by comprising: a furnace body in which a fiber inlet and a fiber outlet are formed in a tube wall of a waveguide; and a microwave oscillator which guides microwaves into the waveguide. The microwave heating unit is characterized in that: continuous fibers to be heated are configured to have an inclination of an angle θ° with respect to the tube shaft of the waveguide and to travel therein; the angle θ° is 0.

### TECHNICAL FIELD

The present invention relates to a microwave heating unit that heats a continuous fiber as a heating subject by irradiating the fiber with microwaves, to the fiber and a method for producing a carbon fiber using the microwave heating unit.

### BACKGROUND ART

Carbon fibers have excellent specific strength and specific elastic modulus as compared with other fibers, and are widely used industrially as reinforcing fibers to be combined with a resin or the like by utilizing their lightweight properties and excellent mechanical properties.

Conventionally, carbon fibers are produced as follows. First, a precursor fiber is subjected to a flame resistance treatment by being heated in a heating air at 230° C. to 260° C. inclusive for 30 minutes to 100 minutes inclusive. By this flame resistance treatment, a cyclization reaction of an acrylic fiber is caused to increase the amount of oxygen bonding, thereby obtaining a flame-resistant fiber. The flame-resistant fiber is carbonized with a temperature gradient using a pyrolyzing furnace at 300° C. to 800° C. inclusive in a nitrogen atmosphere, for example (first carbonization treatment). Next, carbonization is further performed with a temperature gradient using the pyrolyzing furnace at 800° C. to 2100° C. inclusive in the nitrogen atmosphere (second carbonization treatment). Thus, a carbon fiber is produced by heating the flame-resistant fiber from the outside of the fiber in the pyrolyzing furnace which has been heated.

In the case of production as described above, in order to avoid insufficient carbonization of the inside of the fibers to be carbonized, the temperature must be gradually increased over time. In addition, in the pyrolyzing furnace in which the fiber is heated from the outside of the fiber, substances other than the fibers to be carbonized, such as a furnace body and a pyrolyzing atmosphere, are also heated, and thus, the thermal efficiency is low.

So far, attempts have been made to produce carbon fibers through heating carbonized fibers to be carbonized by irradiating the fibers with microwaves to the fibers. A substance is heated by microwaves from the inside thereof. Therefore, when fibers to be carbonized is heated using microwaves, carbonization can be uniformly performed on the surface of the fiber and inside the fiber, and a reduction in the production time of the carbon fiber is expected.

Conventionally, Patent Literature 1 is known as a method for producing a carbon fiber using microwaves.

Patent Literature 1 describes a method for producing a carbon fiber using microwaves.

Further, Patent Literature 2 discloses a microwave heating apparatus that suppresses heating unevenness of food or the like by conveying a heating object obliquely with respect to a heating furnace.

However, in the production process of the carbon fiber, the fiber as the heating subject continuously changes from a dielectric to a semiconductor and then to a conductor. In particular, in the production process of the carbon fiber using microwaves, the properties of the heating subject fiber change instantaneously. That is, a change in the dielectric constant of the heating subject fiber causes suitable heating conditions change instantaneously. Therefore, when the heating subject fiber is heated using the conventional microwave heating unit, an unstable reaction tends to occur due to the properties of electromagnetic energy in the furnace, and the heating subject fiber may be significantly damaged, and thus, the process stability may be deteriorated and the quality of the obtained fiber may be significantly deteriorated.

### CITATION LIST

### Patent Literature

Patent Literature 1: JP 6063045 B
Patent Literature 2: JP 2898646 B

### SUMMARY OF INVENTION

### Technical Problem

The object of the present invention is to provide a small-sized microwave heating unit that heats a fiber as a heating subject by irradiating microwaves to the fiber and is capable of stably heating the fiber as the heating subject when the dielectric constant of the fiber as the heating subject is changed. Another object of the present invention is to provide a method for producing a carbon fiber, wherein a heating subject fiber is carbonized using the microwave heating unit.

### Solution to Problem

The present inventors have found that the above problem can be solved by causing the heating subject continuous fiber to run obliquely with respect to an axis of the furnace body. That is, it has been found that when the electromagnetic field distribution generated in the furnace body reaches a maximum electric field intensity at predetermined positions of a waveguide, by causing the heating subject continuous fiber to run obliquely with respect to the tube axis of the waveguide, the heating subject continuous fiber is heated in the vicinity of the maximum electric field intensity, and the heating subject continuous fiber whose dielectric constant has been changed by the heating is quickly retracted from the vicinity of the maximum electric field intensity, and thereby, the electric field reflection caused by the change of the continuous fiber as the heating subject into a semiconductor or a conductor can be suppressed and the process stability can be improved.

In addition, it has been found that when heating is performed after the continuous fiber as the heating subject which is a dielectric is changed into a semiconductor or a conductor, heating using an electric field component of a microwave tends to cause severance due to electric discharge, the heating becomes unstable, and the quality of the heating subject continuous fiber is significantly deteriorated, and such a problem can be solved by heating using a magnetic field component.

In addition, the present inventors have conceived that a cylindrical heat insulating tube through which microwaves are transmitted is disposed in a cylindrical furnace body and a heating subject continuous fiber is caused to run in the heat insulating tube to be irradiated with microwaves. It has been found that since the heat insulating tube absorbs microwaves and generates heat by itself at a high temperature, the carbonization rate can be remarkably improved by keeping the heating subject continuous fiber at a high temperature.

The present invention has been completed based on these findings.

The present invention for solving the above-described problem is as described below.

[1] A microwave heating unit (1000, 1000a, 1000b, 1000c, 1001, 1002, 1003, 1004) including:
a furnace body (100, 101, 201, 301, 401, 501) that includes a fiber inlet (103, 203, 303) and a fiber outlet (105, 205, 305) which are formed on a tube wall of a waveguide; and
a microwave oscillator (11) for introducing microwaves into the waveguide,
the continuous fiber as the heating subject (150, 250, 350, 450, 550, 251, 351, 451, 551) being configured to run inside the waveguide with an inclination at an angle θ° with respect to a tube axis of the waveguide, the angle θ° satisfying 0<θ<90, and the fiber outlet being formed at a portion other than a terminal end portion of the waveguide.

[2] The microwave heating unit according to [1], wherein the angle θ° satisfies 10<θ<60.

The microwave heating unit of the above-described [1] and [2] uses the waveguide as the furnace body and irradiates the heating subject continuous fiber running inside the waveguide with microwaves under an atmospheric pressure, wherein a fiber as a heating subject is caused to run obliquely with respect to the tube axis of the waveguide.

[3] The microwave heating unit according to [1], wherein the waveguide is a rectangular waveguide, and the fiber inlet and the fiber outlet are respectively provided on a short-side tube wall of the waveguide.

[4] The microwave heating unit according to [1], further including: a heat insulating tube (107, 207, 307) that penetrates the waveguide and connects the fiber inlet and the fiber outlet, wherein the heating subject continuous fiber is configured to run inside the heat insulating tube.

[5] The microwave heating unit according to [1], wherein a material of the heat insulating tube is a ceramic.

In the microwave heating unit of the above-described [4] and [5], an outer periphery of a running portion of the continuous fiber as the heating subject is covered with the heat insulating tube made of ceramic.

[6] A method for producing an intermediate carbon fiber or a carbon fiber, the method heating a continuous fiber as a heating subject while causing the continuous fiber as the heating subject to run using the microwave heating unit according to any one of [1] to [5], and the method including a process of heating a continuous fiber as a heating subject having a carbon content of less than 66% by mass to obtain an intermediate carbon fiber or a carbon fiber.

[7] The method according to [6], wherein a continuous fiber as a heating subject is further heated by a maximum magnetic field portion in a waveguide while being caused to run using the microwave heating unit according to any one of [1] to [5].

The method according to any one of the above-described [6] and [7] is a method for producing a carbon fiber using the microwave heating unit according to any one of [1] to [5] in at least a part of a carbon fiber production process.

### Advantageous Effects of Invention

In the microwave heating unit of the present invention, the heating subject continuous fiber runs obliquely with respect to the axis of the furnace body. Therefore, the continuous fiber as the heating subject which is heated at the maximum electric field portion in the furnace body and changed in property (dielectric constant) can be quickly retracted from the maximum electric field portion. As a result, electric field reflection due to the fiber that has become a semiconductor or a conductor in the furnace is less likely to occur, and the process stability can be improved.

When a rectangular waveguide is used as the furnace body and the fiber inlet and the fiber outlet are loaded on the H-plane of the rectangular waveguide, the width of the furnace body can be reduced and the apparatus can be made compact.

Further, when the heat insulating tube is used, the continuous fiber as the heating subject can be maintained at a high temperature, and thus, the efficiency of carbonization can be improved.

### BRIEF DESCRIPTION OF DRAWINGS

FIG. 1 is an explanatory view illustrating a configuration example of a microwave heating unit of the present invention. A structure of a furnace body is omitted in the drawing.

FIG. 2 is an explanatory view illustrating a configuration example of the furnace body of the microwave heating unit of the present invention.

FIG. 3 is an explanatory view illustrating a configuration example of a furnace body (H-plane loading furnace) of the microwave heating unit of the present invention.

FIG. 4 is an explanatory view illustrating a configuration example of a furnace body (E-plane loading furnace) of the microwave heating unit of the present invention.

FIG. 5 is an explanatory view illustrating an electromagnetic field distribution in the furnace body of FIG. 2.

FIG. 6 is an explanatory view illustrating an electromagnetic field distribution in the furnace body of FIG. 3.

FIG. 7 is an explanatory view illustrating an electromagnetic field distribution in the furnace body of FIG. 4.

FIG. 8 is an explanatory view illustrating an electromagnetic field distribution in the furnace body (H-plane loading furnace) of the microwave heating unit.

FIG. 9 is an explanatory view illustrating an electromagnetic field distribution in the furnace body (E-plane loading furnace) of the microwave heating unit.

FIG. 10 is an explanatory view illustrating the electromagnetic field distribution in the furnace body of FIG. 3.

FIG. 11 is an explanatory view illustrating the electromagnetic field distribution in the furnace body of FIG. 4.

FIG. 12 is an explanatory view illustrating the electromagnetic field distribution in the furnace body (H-plane loading furnace) of the microwave heating unit.

FIG. 13 is an explanatory view illustrating the electromagnetic field distribution in the furnace body (E-plane loading furnace) of the microwave heating unit.

FIG. 14 illustrates a furnace body of a microwave heating unit in which a metal sleeve and a heat insulating tube are not provided.

FIG. 15 illustrates a furnace body of a microwave heating unit without a metal sleeve.

FIG. 16 illustrates a furnace body of a microwave heating unit without a heat insulating tube.

### DESCRIPTION OF EMBODIMENTS

Hereinafter, a microwave heating unit and a method for producing a carbon fiber using the microwave heating unit according to the present invention will be described in detail with reference to the drawings.

In the present invention, the H-plane of the furnace body refers to a short-side tube wall of a rectangular waveguide, and the E-plane of the furnace body refers to a long-side tube wall of the rectangular waveguide.

In the present invention, dielectric, semiconductor and conductor are not distinguished by clear numerical values, and mean that a continuous fiber as a heating subject in a state before being heated is a dielectric, the continuous fiber as the heating subject in a completely heated state is a conductor, and the continuous fiber as the heating subject in an intermediate state therebetween is a semiconductor. That is, when the continuous fiber as the heating subject is a carbon fiber precursor, it means that a carbon fiber precursor (having a carbon content of 66% to 72% inclusive by mass) is a dielectric, a carbon fiber or graphitized fiber is a conductor (having a carbon content of 90% by mass or more), and an intermediate state therebetween is a semiconductor.

(1) Microwave Heating Unit

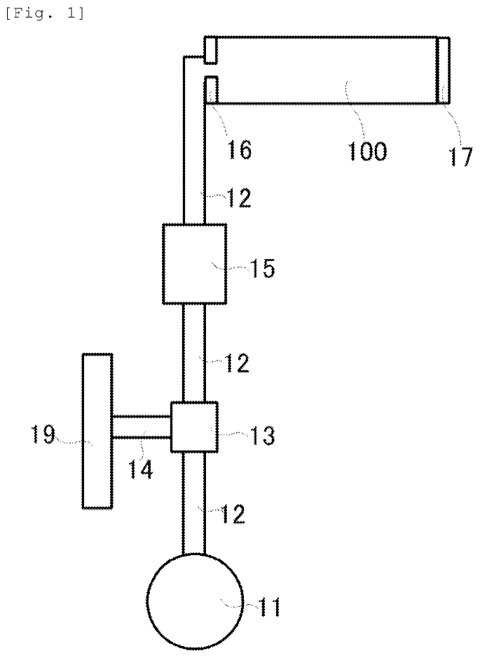

FIG. 1 is an explanatory view illustrating a configuration example of a microwave heating unit of the present invention. In FIG. 1, 11 denotes a microwave oscillator, one end of a connection waveguide 12 is connected to the microwave oscillator 11, and the other end of the connection waveguide 12 is connected to a furnace body 100. A circulator 13 and a matching box 15 are interposed in the connection waveguide 12 sequentially from the side of the microwave oscillator 11. One end of a connection waveguide 14 is connected to the circulator 13, and a dummy load 19 is connected to the other end of the connection waveguide 14. At this time, an iris 16, which is a mechanism for adjusting the inflow amount of the microwave into the furnace body 100 and the outflow amount of the microwave from the furnace body 100 and a short-circuit plate 17 for forming a standing wave may be provided respectively at each end portion of the waveguide.

(2) Furnace Body

The furnace body 100 of the microwave heating unit of the present invention includes a cylindrical waveguide or a rectangular waveguide. By introducing the microwave into the waveguide, an electromagnetic field distribution of a TE (Transverse Electric) mode is formed in the waveguide. A TE mode refers to a transmission mode having an electric field component orthogonal to the direction of the microwave transmitted in the waveguide. By generating a standing wave in the furnace body 100, a place where an electric field component reaches the maximum and a place where a magnetic field component reaches the maximum are present at different positions in the furnace body 100. Therefore, by causing the continuous fiber as the heating subject to run in the furnace body, heating mainly by an electric field component (hereinafter also referred to as “electric field heating”) and heating mainly by a magnetic field component (hereinafter also referred to as “magnetic field heating”) may be respectively performed.

(2-1) Furnace Body Using Cylindrical Waveguide

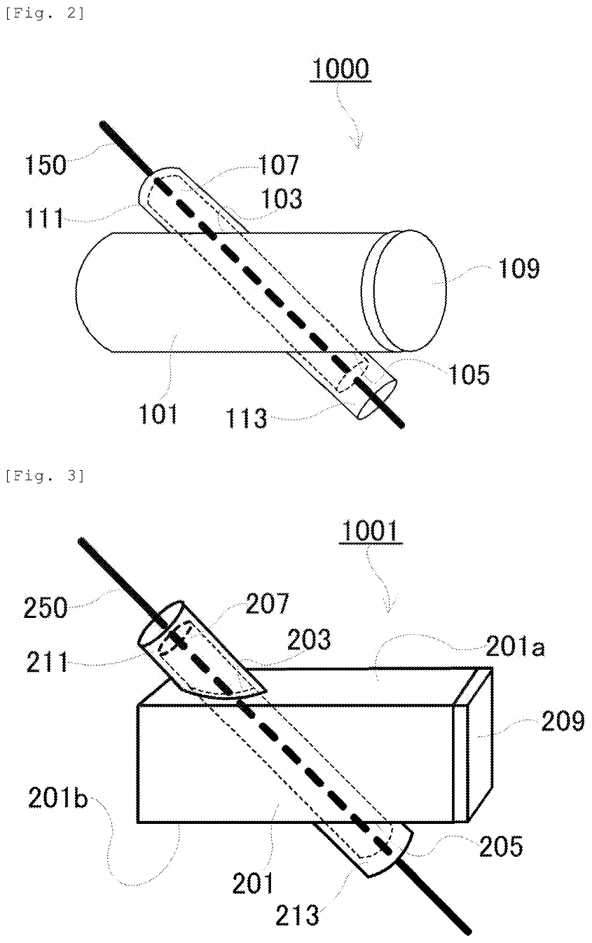

FIG. 2 is an explanatory view illustrating a configuration example of the furnace body of the microwave heating unit of the present invention.

In FIG. 2, reference sign 1000 denotes a microwave heating unit, and reference sign 101 denotes a furnace body constituted of a cylindrical waveguide with at least one end closed. A fiber inlet 103 and a fiber outlet 105 are respectively formed on the outer periphery of the furnace body 101. The furnace body 101 may be provided with a heat insulating tube 107 that penetrates the inside of the furnace body 101 obliquely with respect to a tube axis and connects the fiber inlet 103 and the fiber outlet 105. It is configured that the heat insulating tube 107 carries a continuous fiber as a heating subject 150 therein. A short-circuit plate 109 is disposed at a closed inner end portion of the furnace body 101. The fiber inlet 103 and the fiber outlet 105 may be provided with metal sleeves 111 and 113, respectively, to prevent leakage of electromagnetic waves from the furnace body 101.

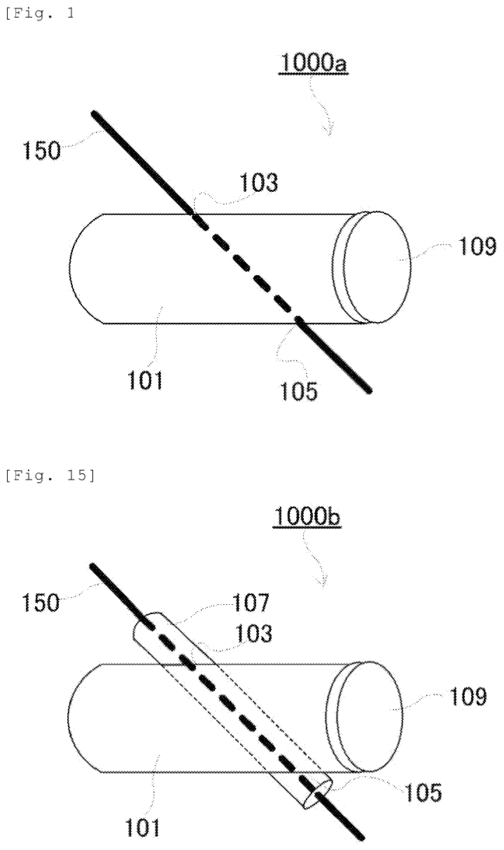

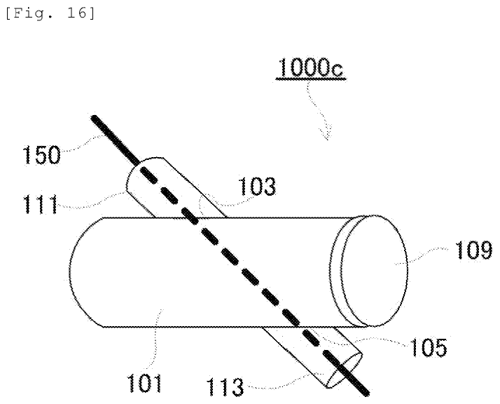

FIG. 14 illustrates a furnace body 1000a of a microwave heating unit in which a metal sleeve and a heat insulating tube are not provided. FIG. 15 illustrates a furnace body 1000b of a microwave heating unit without a metal sleeve. FIG. 16 illustrates a furnace body 1000c of a microwave heating unit without a heat insulating tube. The same components as those in FIG. 2 are denoted by the same reference signs, and the description thereof is omitted.

Next, the operation of the microwave heating unit 1000 will be described. In FIG. 2, reference 150 denotes a continuous fiber as a heating subject, and the fiber is continuously conveyed from the fiber inlet 103 into the furnace body 101 through the inside of the heat insulating tube 107 by a fiber conveying means which is not illustrated. The microwave oscillated by the microwave oscillator 11 is introduced into the furnace body 101 through the inside of the connection waveguide 12 and the iris 16. The microwave that has reached the inside of the furnace body 101 is reflected by the short-circuit plate 109 disposed at the closed inner end portion (terminal end portion) of the furnace body 101 and reaches the circulator 13 via the matching box 15. The reflected microwave (hereinafter also referred to as “reflected wave”) is changed in direction in the circulator 13, passes through the connection waveguide 14, and is absorbed in the dummy load 19. At this time, matching is achieved between the matching box 15 and the short-circuit plate 109 using the matching box 15, and a standing wave is generated in the furnace body 101. Due to the standing wave, a place where the electric field component reaches the maximum (maximum electric field portion) and a place where the magnetic field component reaches the maximum (maximum magnetic field portion) are formed at different positions respectively in the furnace body 101. The continuous fiber as the heating subject 150 is heated by the standing wave. In the microwave heating unit 1000 of the present invention, the running direction of the continuous fiber as the heating subject 150 is oblique to the tube axis, and is neither orthogonal nor parallel to the tube axis. Therefore, the continuous fiber as the heating subject 150 does not run through only the maximum electric field portion or the maximum magnetic field portion. At this time, the inside of the furnace body 101 is at a normal pressure and is in an inert atmosphere supplied by an inert gas supply means which is not illustrated. The continuous fiber as the heating subject 150, which has been heated, is carried out of the furnace body 101 through the fiber outlet 105 by the fiber conveying means which is not illustrated. The continuous fiber as the heating subject 150 can be continuously heated by continuously carrying the continuous fiber as the heating subject from the fiber inlet 103 into the furnace body 101, irradiating the continuous fiber as the heating subject with microwaves in the furnace body 101 to heat the continuous fiber as the heating subject, and continuously carrying out the continuous fiber as the heating subject from the fiber outlet 105.

The angle θ° between the tube axis of the furnace body 101 and the tube axis of the heat insulating tube 107 is 0<θ<90, preferably 10<θ<60, and more preferably 15<θ<55. It is configured that the continuous fiber as the heating subject 150 is carried out of the furnace body from a portion other than the terminal end portion of the furnace body. That is, the fiber outlet 105 is formed on the outer peripheral surface along the tube axis of the furnace body 101. By obliquely intersecting the tube axis of the furnace body 101 with the tube axis of the heat insulating tube 107, the running direction of the continuous fiber as the heating subject is inclined with respect to the tube axes, and thus, while running in the maximum electric field portion or the maximum magnetic field portion, the continuous fiber as the heating subject can be prevented from running only in the maximum electric field portion or the maximum magnetic field portion. As a result, the process stability can be improved as described below. The angle θ° between the tube axis of the furnace body 101 and the continuous fiber as the heating subject 150 is 0<θ<90, preferably 10<θ<60, and more preferably 15<θ<55.

(2-2) Furnace Body Using Rectangular Waveguide

(a) H-Plane Loading Furnace

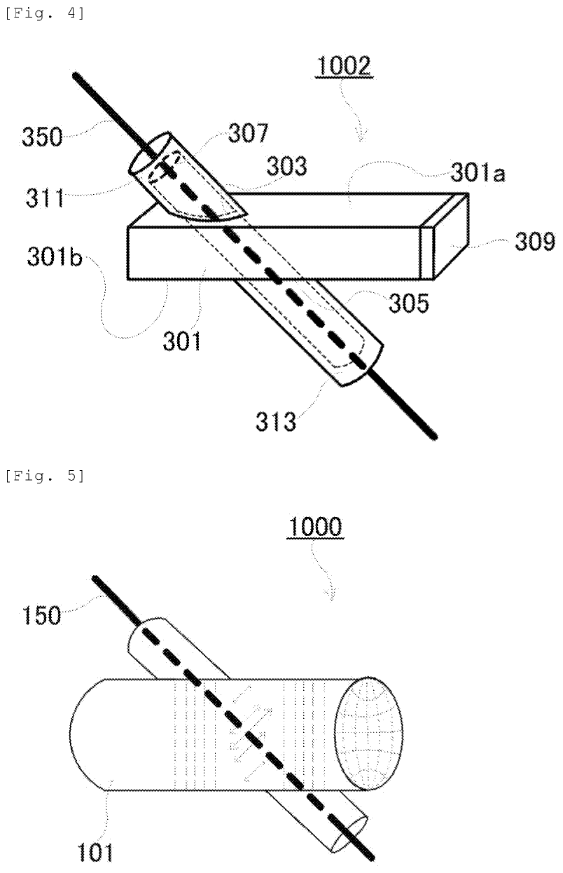

FIG. 3 is an explanatory view illustrating a configuration example of the furnace body of the microwave heating unit of the present invention. In FIG. 3, reference sign 1001 denotes a microwave heating unit, and reference sign 201 denotes a furnace body constituted of a rectangular waveguide with at least one end closed. A fiber inlet 203 and a fiber outlet 205 are formed on two H-planes 201a, 201b, which are short-side tube walls of the furnace body 201, respectively. The furnace body 201 may be provided with a heat insulating tube 207 that penetrates the inside of the furnace body 201 obliquely and connects the fiber inlet 203 and the fiber outlet 205. It is configured that the heat insulating tube 207 carries a continuous fiber as a heating subject 250 therein. A short-circuit plate 209 is disposed at a closed inner end portion of the furnace body 201. The fiber inlet 203 and the fiber outlet 205 may be provided with metal sleeves 211 and 213, respectively, to prevent leakage of electromagnetic waves from the furnace body 201. As in the case of using the cylindrical waveguide, when the rectangular waveguide is used, the heat insulating tube and/or the metal sleeves can also be omitted.

Next, the operation of the microwave heating unit 1001 will be described. In FIG. 3, reference sign 250 denotes a continuous fiber as a heating subject, and the fiber is continuously conveyed from the fiber inlet 203 into the furnace body 201 through the inside of the heat insulating tube 207 by a fiber conveying means which is not illustrated. The microwave oscillated by the microwave oscillator 11 is introduced into the furnace body 201 through the inside of the connection waveguide 12 and the iris 16. The microwave that has reached the inside of the furnace body 201 is reflected by the short-circuit plate 209 disposed at the closed inner end portion (terminal end portion) of the furnace body 201 and reaches the circulator 13 via the matching box 15. The reflected wave is changed in direction in the circulator 13, passes through the connection waveguide 14, and is absorbed in the dummy load 19. At this time, matching is achieved between the matching box 15 and the short-circuit plate 209 using the matching box 15, and a standing wave is generated in the furnace body 201. Due to the standing wave, a place where the electric field component reaches the maximum (maximum electric field portion) and a place where the magnetic field component reaches the maximum (maximum magnetic field portion) are formed at different positions respectively in the furnace body 201. The continuous fiber as heating subject 250 is heated by the standing wave. In the microwave heating unit 1001 of the present invention, the running direction of the continuous fiber as the heating subject 250 is oblique to the tube axis, and is neither orthogonal nor parallel to the tube axis. Therefore, the continuous fiber as the heating subject 250 does not run through only the maximum electric field portion or the maximum magnetic field portion. At this time, the inside of the furnace body 201 is at a normal pressure and is in an inert atmosphere supplied by an inert gas supply means which is not illustrated. The continuous fiber as the heating subject 250, which has been heated, is carried out of the furnace body 201 through the fiber outlet 205 by the fiber conveying means which is not illustrated. The continuous fiber as the heating subject 250 can be continuously heated by continuously carrying the continuous fiber as the heating subject from the fiber inlet 203 into the furnace body 201, irradiating the continuous fiber as the heating subject with microwaves in the furnace body 201 to heat the continuous fiber as the heating subject, and continuously carrying out the continuous fiber as the heating subject from the fiber outlet 205.

The angle θ° between the tube axis of the furnace body 201 and the tube axis of the heat insulating tube 207 is 0<θ<90, preferably 10<θ<60, and more preferably 15<θ<55. It is configured that the continuous fiber as the heating subject 250 is carried out of the furnace body from a portion other than the terminal end portion of the furnace body. That is, the fiber outlet 205 is formed on the H-plane 201b of the furnace body 201. By obliquely intersecting the tube axis of the furnace body 201 with the tube axis of the heat insulating tube 207, the running direction of the heating subject continuous fiber is inclined with respect to the tube axes, and thus, while running in the maximum electric field portion or the maximum magnetic field portion, the heating subject continuous fiber can be prevented from running only in the maximum electric field portion or the maximum magnetic field portion. As a result, the process stability can be improved as described below. The angle θ° between the tube axis of the furnace body 201 and the continuous fiber as the heating subject 250 is 0<θ<90, preferably 10<θ<60, and more preferably 15<θ<55.

In the present invention, it is preferable that the furnace is an H-plane loading furnace capable of reducing a machine width and an equal pitch.

(b) E-Plane Loading Furnace

FIG. 4 is an explanatory view illustrating another configuration example of the furnace body of the microwave heating unit of the present invention. In FIG. 4, 1002 denotes a microwave heating unit, and 301 denotes a furnace body constituted of a rectangular waveguide with at least one end closed. A fiber inlet 303 and a fiber outlet 305 are formed on two E-planes 301a, 301b, which are long-side tube walls of the furnace body 301, respectively. The furnace body 301 is provided with a heat insulating tube 307 that penetrates the inside of the furnace body 301 obliquely and connects the fiber inlet 303 and the fiber outlet 305. It is configured that the heat insulating tube 307 carries a heating subject continuous fiber 350 therein. A short-circuit plate 309 is disposed at a closed inner end portion of the furnace body 301. The fiber inlet 303 and the fiber outlet 305 may be provided with metal sleeves 311 and 313, respectively, to prevent leakage of electromagnetic waves from the furnace body 301.

Since the operation of the microwave heating unit 1002 is the same as that of the above-described microwave heating unit 1001, the description thereof is omitted.

(3) Electric Field Heating

Hereinafter, a configuration of a furnace body for heating the carbon fiber precursor which is a dielectric by electric field heating will be described.

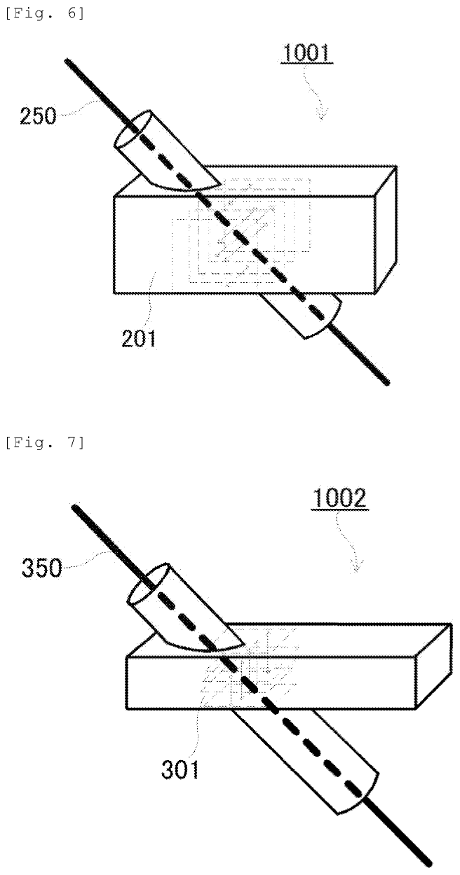

FIG. 5 is an explanatory diagram illustrating an example of an electromagnetic field distribution in the furnace body 101 of the microwave heating unit of FIG. 2. The furnace body 101 is configured to include a maximum electric field portion in a running portion of the continuous fiber as the heating subject 150 (carbon fiber precursor). In FIG. 5, the electric field distribution in the furnace body 101 is schematically illustrated by a solid line, and the magnetic field distribution in the furnace body 101 is schematically illustrated by a broken line. In the furnace body 101, an electric field component orthogonal to the continuous fiber as the heating subject 150 (carbon fiber precursor) running in the furnace body 101 is formed, and thereby the continuous fiber as the heating subject 150 (carbon fiber precursor) is heated. At this time, the running direction of the continuous fiber as the heating subject 150 (carbon fiber precursor) is obliquely intersected with the tube axis of the furnace body 101, and thus, the continuous fiber as the heating subject 150 passes through not only the maximum electric field portion in the furnace body 101 but also the weak electric field portion in the furnace body 101. That is, it is configured that the continuous fiber as the heating subject 150 (carbon fiber precursor) carried into the furnace body 101 from the fiber inlet 103 sequentially passes through the weak electric field portion, the maximum electric field portion, and the weak electric field portion in the furnace body 101, and is carried out of the furnace body 101 from the fiber outlet 105. After the carbon fiber precursor is changed to a semiconductor or a conductor by being heated at the maximum electric field portion, the fiber as the heating subject is quickly retracted from the maximum electric field portion. Therefore, the irradiation state of the microwave in the furnace body can be stabilized. At this time, it is preferable to provide the fiber inlet on the upper side of the furnace body 101 because the heat generated from the furnace body can be discharged to the upper side of the furnace body and the continuous fiber as the heating subject 150 (carbon fiber precursor) can be preheated.

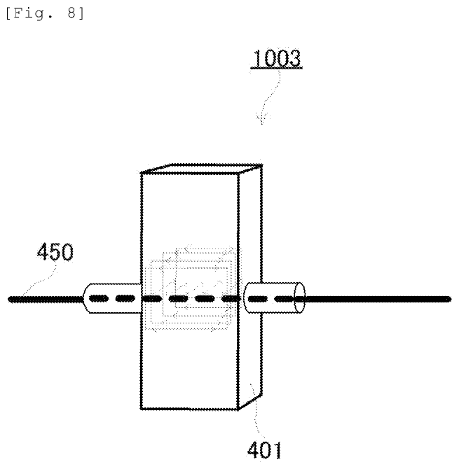

FIG. 6 is an explanatory diagram illustrating an electromagnetic field distribution in the furnace body 201 of the microwave heating unit of FIG. 3. The furnace body 201 is an H-plane loading furnace. The H-plane loading furnace is configured to include a maximum electric field portion in a running portion of the continuous fiber as the heating subject 250 (carbon fiber precursor). In FIG. 6, the electric field distribution in the furnace body 201 is schematically illustrated by a solid line, and the magnetic field distribution in the furnace body 201 is schematically illustrated by a broken line. In the furnace body, an electric field component orthogonal to the continuous fiber as the heating subject 250 (carbon fiber precursor) running in the furnace body 201 is formed, and thereby the continuous fiber as the heating subject 250 (carbon fiber precursor) is heated. At this time, the running direction of the continuous fiber as the heating subject 250 (carbon fiber precursor) is obliquely intersected with the tube axis of the furnace body 201, and thus, the continuous fiber as the heating subject 250 passes through not only the maximum electric field portion in the furnace body 201 but also the weak electric field portion in the furnace body 201. That is, it is configured that the continuous fiber as the heating subject 250 (carbon fiber precursor) carried into the furnace body 201 from the fiber inlet 203 sequentially passes through the weak electric field portion, the maximum electric field portion, and the weak electric field portion in the furnace body 201, and is carried out of the furnace body 201 from the fiber outlet 205. After the carbon fiber precursor is changed to a semiconductor or a conductor by being heated at the maximum electric field portion, the fiber as the heating subject is quickly retracted from the maximum electric field portion. Therefore, the irradiation state of the microwave in the furnace body can be stabilized. At this time, it is preferable to provide the fiber inlet on the upper side of the furnace body 201 because the heat generated from the furnace body can be discharged to the upper side of the furnace body and the continuous fiber as the heating subject 250 (carbon fiber precursor) can be preheated.

FIG. 7 is an explanatory diagram illustrating an electromagnetic field distribution in the furnace body 301 of the microwave heating unit of FIG. 4. The furnace body 301 is an E-plane loading furnace. The E-plane loading furnace is configured to include a maximum electric field portion in a running portion of the continuous fiber as the heating subject 350 (carbon fiber precursor). In FIG. 7, the electric field distribution in the furnace body 301 is schematically illustrated by a solid line, and the magnetic field distribution in the furnace body 301 is schematically illustrated by a broken line. In the furnace body, a part of the electric field component is formed in the longitudinal direction of the continuous fiber as the heating subject 350 (carbon fiber precursor) running in the furnace body 301, and thereby the continuous fiber as the heating subject 350 (carbon fiber precursor) is efficiently heated. At this time, the running direction of the continuous fiber as the heating subject 350 (carbon fiber precursor) is obliquely intersected with the tube axis of the furnace body 301, and thus, the continuous fiber as the heating subject 350 passes through not only the maximum electric field portion in the furnace body 301 but also the weak electric field portion in the furnace body 301. That is, it is configured that the continuous fiber as the heating subject 350 (carbon fiber precursor) carried into the furnace body 301 from the fiber inlet 303 sequentially passes through the weak electric field portion, the maximum electric field portion, and the weak electric field portion in the furnace body 301, and is carried out of the furnace body 301 from the fiber outlet 305. After the carbon fiber precursor changes to a semiconductor or a conductor by being heated at the maximum electric field portion which includes the electric field component in the longitudinal direction of the continuous fiber as the heating subject 350 (carbon fiber precursor), the fiber as the heating subject is quickly retracted from the maximum electric field portion. Therefore, the irradiation state of the microwave in the furnace body can be stabilized.

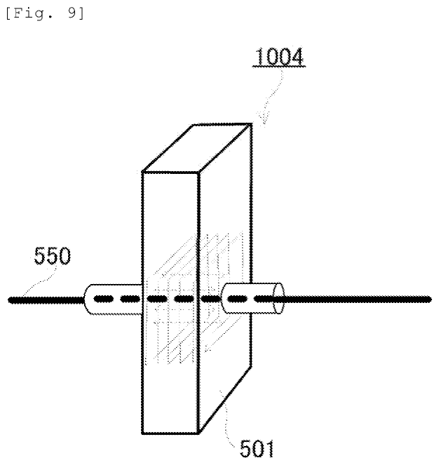

FIG. 8 is an explanatory diagram illustrating an electromagnetic field distribution in the furnace body 401 of the microwave heating unit 1003. The furnace body 401 is an H-plane loading furnace. It is configured that in the H-plane loading furnace, the continuous fiber as the heating subject 450 (carbon fiber precursor) runs in the maximum electric field portion. In FIG. 8, the electric field distribution in the furnace body 401 is schematically illustrated by a broken line, and the magnetic field distribution in the furnace body 401 is schematically illustrated by a solid line. In the furnace body, an electric field component orthogonal to the long-side tube wall of the furnace body 401 is formed, and thereby the continuous fiber as the heating subject 450 (carbon fiber precursor) is heated. That is, it is configured that the continuous fiber as the heating subject 450 (carbon fiber precursor) carried into the furnace body 401 from the fiber inlet is carried out of the furnace body 401 from the fiber outlet through the maximum electric field portion in the furnace body 401.

FIG. 9 is an explanatory diagram illustrating an electromagnetic field distribution in the furnace body 501 of the microwave heating unit 1004. The furnace body 501 is an E-plane loading furnace. It is configured that in the E-plane loading furnace, the continuous fiber as the heating subject 550 (carbon fiber precursor) runs in the maximum electric field portion. In FIG. 9, the electric field distribution in the furnace body 501 is schematically illustrated by a broken line, and the magnetic field distribution in the furnace body 501 is schematically illustrated by a solid line. In the furnace body, an electric field component is formed parallel to the long-side tube wall of the furnace body 501 and parallel to the running continuous fiber as the heating subject 550 (carbon fiber precursor), and thereby the continuous fiber as the heating subject 550 (carbon fiber precursor) is heated. That is, it is configured that the continuous fiber as the heating subject 550 (carbon fiber precursor) carried into the furnace body 501 from the fiber inlet is carried out of the furnace body 501 from the fiber outlet through the maximum electric field portion in the furnace body 501.

(4) Magnetic Field Heating

Hereinafter, the configuration of a furnace body for heating the continuous fiber as the heating subject which is a semiconductor or a conductor by magnetic field heating will be described.

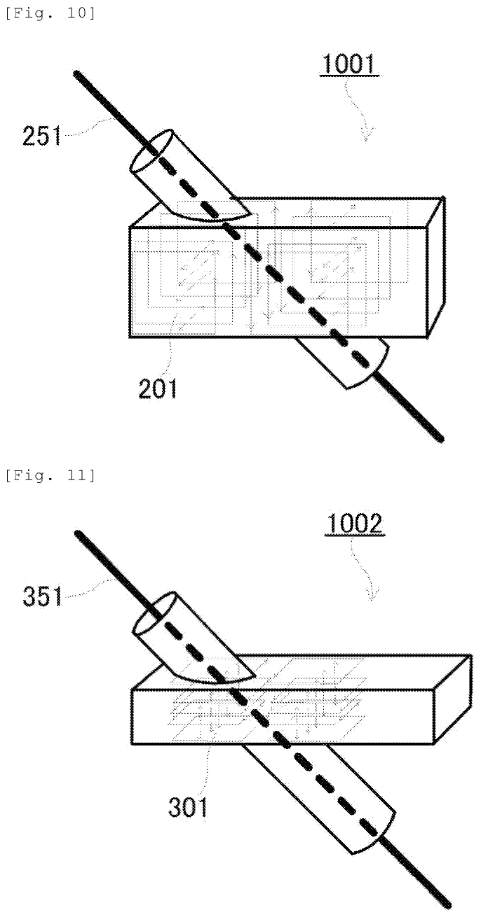

FIG. 10 is an explanatory diagram illustrating an electromagnetic field distribution in the furnace body 201 of the microwave heating unit of FIG. 3. The furnace body 201 is an H-plane loading furnace. The H-plane loading furnace is configured to include a maximum magnetic field generating portion in a running portion of a continuous fiber as a heating subject 251. In FIG. 10, the electric field distribution in the furnace body 201 is schematically illustrated by a broken line, and the magnetic field distribution in the furnace body 201 is schematically illustrated by a solid line. In the furnace body, a magnetic field component parallel to the long-side tube wall of the furnace body 201 is formed, and thereby the heating subject continuous fiber 251 is heated. At this time, the running direction of continuous fiber as the heating subject 251 is obliquely intersected with the tube axis of the furnace body 201, and thus, the continuous fiber as the heating subject 251 passes through not only the maximum magnetic field portion in the furnace body 201 but also the weak magnetic field portion in the furnace body 201. That is, it is configured that the continuous fiber as the heating subject 251 carried into the furnace body 201 from the fiber inlet 203 sequentially passes through the weak magnetic field portion, the maximum magnetic field portion, and the weak magnetic field portion in the furnace body 201, and is carried out of the furnace body 201 from the fiber outlet 205. By being heated at the maximum magnetic field portion and avoiding the maximum electric field portion, the irradiation state of the microwave in the furnace body can be stabilized. Since the fiber as the heating subject sequentially passes through the weak magnetic field portion, the maximum magnetic field portion, and the weak magnetic field portion, the temperature of the continuous fiber as the heating subject tends to decrease. Therefore, it is preferable to use a heat insulating tube to be described later.

FIG. 11 is an explanatory diagram illustrating an electromagnetic field distribution in the furnace body 301 of the microwave heating unit of FIG. 4. The furnace body 301 is an E-plane loading furnace. The E-plane loading furnace is configured to include a maximum magnetic field portion in a running portion of a continuous fiber as a heating subject 351. In FIG. 11, the electric field distribution in the furnace body 301 is schematically illustrated by a broken line, and the magnetic field distribution in the furnace body 301 is schematically illustrated by a solid line. In the furnace body, a magnetic field component parallel to the long-side tube wall of the furnace body 301 is formed, and thereby the continuous fiber as the heating subject 351 is heated. At this time, the running direction of the continuous fiber as the heating subject 351 is obliquely intersected with the tube axis of the furnace body 301, and thus, the continuous fiber as the heating subject 351 passes through not only the maximum magnetic field portion in the furnace body 301 but also the weak magnetic field portion in the furnace body 301. That is, it is configured that the continuous fiber as the heating subject 351 carried into the furnace body 301 from the fiber inlet 303 sequentially passes through the weak magnetic field portion, the maximum magnetic field portion, and the weak magnetic field portion in the furnace body 301, and is carried out of the furnace body 301 from the fiber outlet 305. By being heated at the maximum magnetic field portion and avoiding the maximum electric field portion, the irradiation state of the microwave in the furnace body can be stabilized. Since the continuous fiber as the heating subject sequentially passes through the weak magnetic field portion, the maximum magnetic field portion, and the weak magnetic field portion, the temperature of the continuous fiber as the heating subject tends to decrease. Therefore, it is preferable to use a heat insulating tube to be described later.

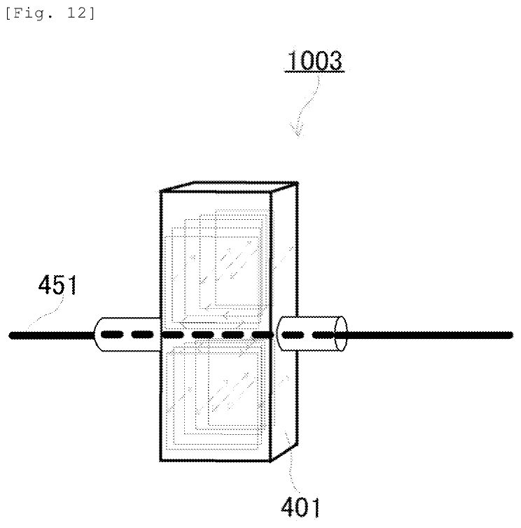

FIG. 12 is an explanatory diagram illustrating an electromagnetic field distribution in the furnace body 401 of the microwave heating unit 1003. The furnace body 401 is an H-plane loading furnace. It is configured that in the H-plane loading furnace, the continuous fiber as the heating subject runs in the maximum magnetic field portion. In FIG. 12, the electric field distribution in the furnace body 401 is schematically illustrated by a broken line, and the magnetic field distribution in the furnace body 401 is schematically illustrated by a solid line. In the furnace body, a magnetic field component parallel to the long-side tube wall of the furnace body 401 is formed, and thereby the continuous fiber as the heating subject 451 is heated. That is, it is configured that the continuous fiber as the heating subject 451 carried into the furnace body 401 from the fiber inlet avoids the maximum electric field portion in the furnace body 401 and is carried out of the furnace body 401 from the fiber outlet through the maximum magnetic field portion.

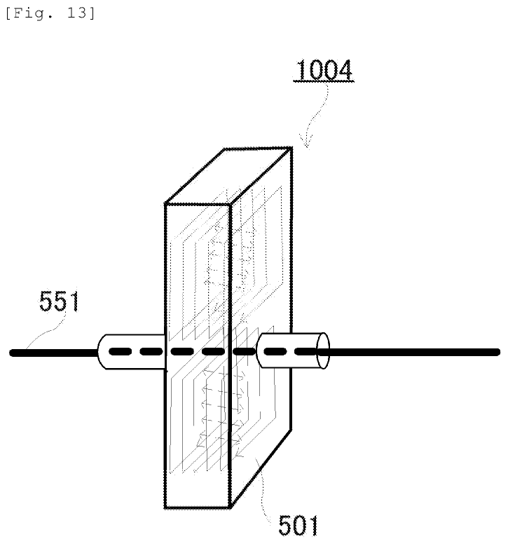

FIG. 13 is an explanatory diagram illustrating an electromagnetic field distribution in the furnace body 501 of the microwave heating unit 1004. The furnace body 501 is an E-plane loading furnace. It is configured that in the E-plane loading furnace, the continuous fiber as the heating subject runs in the maximum magnetic field portion. In FIG. 13, the electric field distribution in the furnace body 501 is schematically illustrated by a broken line, and the magnetic field distribution in the furnace body 501 is schematically illustrated by a solid line. In the furnace body, a magnetic field component is formed to be parallel to the long-side tube wall of the furnace body 501 and orthogonal to the running continuous fiber as the heating subject, and thereby the continuous fiber as the heating subject 551 is heated. That is, it is configured that the carbon fiber precursor 551 carried into the furnace body 501 from the fiber inlet avoids the maximum electric field portion in the furnace body 501 and is carried out of the furnace body 501 from the fiber outlet through the maximum magnetic field portion.

(5) Heat Insulating Tube

It is preferable that the microwave heating unit of the present invention includes a heat insulating tube. The heat insulating tube is inserted into the furnace body in a manner of penetrating the furnace body and connecting the fiber inlet and the fiber outlet, wherein the heating subject continuous fiber is capable of running inside the heat insulating tube. The heat insulating tube keeps the inside of the tube at a high temperature by blocking the radiant heat generated by the heating of the heating subject continuous fiber and thereby suppressing heat dissipation. The inside of the heat insulating tube is at the normal pressure and is in the inert atmosphere supplied by the inert gas supply means which is not illustrated.

It is preferable that the heat insulating tubes 107, 207, 307 are cylindrical. The inner diameters of the heat insulating tubes 107, 207, 307 are not particularly limited, but are generally 8 mm to 55 mm inclusive. The outer diameters of the heat insulating tubes 107, 207, 307 are not particularly limited, but are generally 10 mm to 60 mm inclusive. The lengths of the heat insulating tubes 107, 207, 307 are not particularly limited, but are generally 100 mm to 2500 mm inclusive. In addition, the material of the heat insulating tubes 107, 207, 307 needs to be a material that transmits microwaves, and the transmittance of microwaves is preferably 90% to 100% inclusive and more preferably 95% to 100% inclusive at room temperature (25° C.). Examples of such a material include a ceramic of quartz, alumina, etc. The microwave transmittances of these materials are 100% for quartz and 99.9% for alumina, respectively. The microwave transmittances of the ceramics vary depending on the composition, and the microwave transmittance is 99.9% in the case of silica 41%-alumina 55%, but the composition is not limited to this combination as long as the microwave transmittance is within the above-described range. The ceramic may contain metal oxides such as alumina, silica-alumina, titania, zirconia, magnesia, and calcia; metal nitrides such as silicon nitride, aluminum nitride, and titanium nitride; and other compounds. In particular, alumina or silica-alumina is preferable because alumina or silica-alumina functions as a susceptor that absorbs a part of microwaves and generates heat at a high temperature. At both ends of each of the heat insulating tubes 107, 207, 307, a material which absorbs microwaves may be provided to prevent microwave leakage.

The shape of the waveguide used as the furnace body is not particularly limited as long as an electromagnetic field distribution of the TE mode can be formed in the waveguide. In general, it is preferable that the length of the waveguide is 500 mm to 1500 mm inclusive. It is preferable that the opening of the cross section orthogonal to the tube axis of the rectangular waveguide has a long side of 105 mm to 115 mm inclusive and a short side of 50 mm to 60 mm inclusive. The material of the waveguide is not particularly limited, but is generally made of a metal such as stainless steel, iron, copper, or aluminum.

The frequency of the microwaves is not particularly limited, but generally 915 MHz, 2.45 GHz or 5.8 GHz is used. The output of the microwave oscillator is not particularly limited, but is suitably 300 W to 2400 W inclusive, and more suitably 500 W to 2000 W inclusive.

The conveying speed of a fiber to be carbonized in a carbonization furnace is preferably 0.05 m/min to 10 m/min inclusive, more preferably 0.1 m/min to 5.0 m/min inclusive, and particularly preferably 0.2 m/min to 2.0 m/min inclusive.

The carbon fiber thus obtained has a carbon content of preferably 90% by mass or more, more preferably 91% by mass or more.

(6) Method for Producing Carbon Fiber

When a carbon fiber is produced using the microwave heating unit of the present invention, a plurality of the microwave heating units of the present invention can be connected in series to perform heating. Further, a microwave heating unit other than the microwave heating unit of the present invention may be included, or a heating device other than a microwave heating unit may be included.

### EXAMPLES

Hereinafter, the present invention will be described in more detail with reference to examples. The present invention is not limited to these examples.

In the following examples, the carbon fiber precursor fiber refers to a PAN-based flame-resistant fiber having a carbon content of 60% by mass, and the intermediate carbon fiber refers to a PAN-based intermediate carbon fiber having a carbon content of 66% by mass unless otherwise specified. “Processability” is evaluated as E when the single filament can be continuously carbonized (continuous operation) without breaking, as “o” when a part of the single filament is broken but the continuous operation is possible, as “A” when the single filament is broken and the broken single filament is thus entangled with a conveying device such as a roll and easily hinders the continuous operation, and as “x” when the entire fiber bundle is broken and cannot be taken out from the furnace body. “Fiber quality” is evaluated as “E” when the fiber is not broken at all during carbonization, as “o” when a very small amount of fluff is generated on the fiber during carbonization, as “A” when a large amount of fluff is generated, and as “x” when the fiber is completely broken.

### Example 1

The microwave heating unit described in FIG. 1 (microwave oscillator frequency: 2.45 GHz) is configured. A rectangular waveguide having an opening of 110 mm×55 mm in a cross section orthogonal to the tube axis and a length of 500 mm is used as the furnace body to obtain the configuration illustrated in FIG. 3. The fiber inlet and fiber outlet are provided on the H-plane (short-axis tube wall) of the furnace body. The angle θ between the axis of the furnace body and the fiber running direction is configured to be 37°. At this time, the length of the fiber housed in the furnace body (that is, the length of a line segment connecting the center of the fiber inlet and the center of the fiber outlet. The same applies hereinafter) is 183 mm. A cylindrical silica-alumina tube (transmittance of microwaves=99.9%) having an inner diameter of 15 mm, an outer diameter of 17 mm, and a length of 300 mm is used as the heat insulating tube.

Microwaves are introduced into the furnace body in a nitrogen gas atmosphere to form the electromagnetic field distribution of the TE mode. The output of the microwave oscillator is configured to be 300 W. A carbon fiber precursor is carbonized while being caused to run at 0.3 m/min in a manner that the carbon fiber precursor which is a dielectric and the maximum electric field portion in the furnace body intersect at the axis of the furnace body to obtain a carbon fiber. The carbon content of the obtained carbon fiber is 93% by mass, no breakage of the fiber is found, and the processability is extremely good. The evaluation results are illustrated in Table 1.

### Example 2

An intermediate carbon fiber is obtained by heating in the same manner as in Example 1 except that the angle between the axis of the furnace body and the fiber running direction is changed to 54°. At this time, the length of the fiber housed in the furnace body is 136 mm. Although some single filaments are found broken during the process, the processability is good. The evaluation results are illustrated in Table 1.

### Example 3

An intermediate carbon fiber is obtained by heating in the same manner as in Example 1 except that the angle between the axis of the furnace body and the fiber running direction is changed to 17° and the length of the heat insulating tube is changed to 500 mm. At this time, the length of the fiber housed in the furnace body is 376 mm. Although the temperature of the furnace has risen, during the process, it does not reach a temperature sufficient for the carbonization reaction of the fiber, and the intermediate carbon fiber and carbon fiber cannot be obtained. The evaluation results are illustrated in Table 1.

### Comparative Example 1

The microwave heating unit described in FIG. 1 (microwave oscillator frequency: 2.45 GHz) is configured. A rectangular waveguide having an opening of 110 mm×55 mm in a cross section orthogonal to the tube axis and a length of 500 mm is used as the furnace body. The fiber inlet is provided on a microwave introduction surface of the furnace body, and the fiber outlet is provided at the terminal end portion of the furnace body. The angle between the axis of the furnace body and the fiber running direction is configured to be 0°. At this time, the length of the fiber housed in the furnace body is 500 mm. A cylindrical silica-alumina tube (transmittance of microwaves=99.9%) having an inner diameter of 15 mm, an outer diameter of 17 mm, and a length of 600 mm is used as the heat insulating tube. Microwaves are introduced into the furnace body in a nitrogen gas atmosphere to form the electromagnetic field distribution of the TE mode. The output of the microwave oscillator is configured to be 300 W. A carbon fiber precursor is carbonized while being caused to run at 0.3 m/min in a manner of passing through the inside of the furnace body. At this time, since the maximum electric field portion and the maximum magnetic field portion are alternately present in the furnace body, the transition between the maximum electric field portion and the maximum magnetic field portion is repeated in the electromagnetic field to which the fiber is exposed. During the process, the fiber is broken and the processability is very poor and the intermediate carbon fiber and carbon fiber cannot be obtained. The evaluation results are illustrated in Table 1.

### Comparative Example 2

The microwave heating unit described in FIG. 1 (microwave oscillator frequency: 2.45 GHz) is configured. A rectangular waveguide having an opening of 110 mm×55 mm in a cross section orthogonal to the tube axis and a length of 500 mm is used as the furnace body to obtain the configuration illustrated in FIG. 8. The fiber inlet and fiber outlet are provided on the H-plane (short-axis tube wall) of the furnace body. The angle between the axis of the furnace body and the fiber running direction is configured to be 90°. At this time, the length of the fiber housed in the furnace body is 110 mm. A cylindrical silica-alumina tube (transmittance of microwaves=99.9%) having an inner diameter of 15 mm, an outer diameter of 17 mm, and a length of 300 mm is used as the heat insulating tube. Microwaves are introduced into the furnace body in a nitrogen gas atmosphere to form the electromagnetic field distribution of the TE mode. The output of the microwave oscillator is configured to be 300 W. A carbon fiber precursor is carbonized while being caused to run at 0.3 m/min in a manner of passing through only the maximum electric field portion in the furnace body. During the process, the fiber is broken and the processability is very poor and the intermediate carbon fiber and carbon fiber cannot be obtained. The evaluation results are illustrated in Table 1.

### Example 4

A carbon fiber is obtained by heating in the same manner as in Example 1 except that the carbon fiber precursor and the maximum magnetic field portion in the furnace body are changed to intersect at the axis of the furnace body. At this time, the length of the fiber housed in the furnace body is 183 mm. The carbon content of the obtained carbon fiber is 93% by mass, no breakage of the fiber is found, and the processability is extremely good. The evaluation results are illustrated in Table 1.

### Example 5

An intermediate carbon fiber is obtained by heating in the same manner as in Example 4 except that the angle between the axis of the furnace body and the fiber running direction is changed to 54°. At this time, the length of the fiber housed in the furnace body is 136 mm. The carbon content of the obtained intermediate carbon fiber is 70% by mass, and although some single yarns are found broken during the process, the processability is good. The evaluation results are illustrated in Table 1.

### Example 6

An intermediate carbon fiber is obtained by heating in the same manner as in Example 4 except that the angle between the axis of the furnace body and the fiber running direction is changed to 17° and the length of the heat insulating tube is changed to 500 mm. At this time, the length of the fiber housed in the furnace body is 376 mm. Although the temperature of the furnace has risen, during the process, the temperature rise is not sufficient for the carbonization reaction of the fiber, and the intermediate carbon fiber and carbon fiber cannot be obtained. The evaluation results are illustrated in Table 1.

### Comparative Example 3

The heating is performed in the same manner as in Comparative Example 2 except that the carbon fiber precursor and the maximum magnetic field portion in the furnace body are changed to intersect at the axis of the furnace body (that is, the configuration of FIG. 12). At this time, the length of the fiber housed in the furnace body is 110 mm. During the process, a temperature rise of the fiber is not found and the intermediate carbon fiber and carbon fiber cannot be obtained. The evaluation results are illustrated in Table 1.

### Example 7

An intermediate carbon fiber is obtained by heating in the same manner as in Example 1 except that the fiber inlet and fiber outlet are loaded on the E-plane of the furnace body (that is, the configuration of FIG. 4) and the position where the carbon fiber precursor and the axis of the furnace body intersect is changed from the maximum electric field portion to the maximum magnetic field portion. At this time, the length of the fiber housed in the furnace body is 91 mm. The carbon content of the obtained intermediate carbon fiber is 74% by mass, no breakage of the fiber is found, and the processability is extremely good. The evaluation results are illustrated in Table 1.

### Example 8

An intermediate carbon fiber is obtained by heating in the same manner as in Example 7 except that the angle between the axis of the furnace body and the fiber running direction is changed to 54°. At this time, the length of the fiber housed in the furnace body is 68 mm. The carbon content of the obtained intermediate carbon fiber is 72% by mass, some single yarns are found broken, and the heating subject fiber tends to wind around a conveying roll. The evaluation results are illustrated in Table 1.

### Example 9

An intermediate carbon fiber is obtained by heating in the same manner as in Example 7 except that the angle between the axis of the furnace body and the fiber running direction is changed to 17°. At this time, the length of the fiber housed in the furnace body is 188 mm. No breakage of the fiber is found, and the processability is extremely good. The evaluation results are illustrated in Table 1.

### Comparative Example 4

As in the configuration illustrated in FIG. 13, heating is performed in the same manner as in Comparative Example 3 except that the fiber inlet and fiber outlet are provided on the E-plane (long-axis tube wall) of the furnace body. At this time, the length of the fiber housed in the furnace body is 55 mm. During the process, a temperature rise of the fiber is not found and the intermediate carbon fiber and carbon fiber cannot be obtained. The evaluation results are illustrated in Table 1.

### Example 10

An intermediate carbon fiber is obtained by heating in the same manner as in Example 7 except that the carbon fiber precursor and the maximum electric field portion in the furnace body are changed to intersect at the axis of the furnace body. At this time, the length of the fiber housed in the furnace body is 91 mm. The carbon content of the obtained intermediate carbon fiber is 72%, no breakage of the fiber is found, and the processability is extremely good. The evaluation results are illustrated in Table 1.

### Example 11

An intermediate carbon fiber is obtained by heating in the same manner as in Example 10 except that the angle between the axis of the furnace body and the fiber running direction is changed to 54°. At this time, the length of the fiber housed in the furnace body is 68 mm. Some single yarns are found broken during the process, and the fiber as the heating subject tends to wind around the conveying roll. The evaluation results are illustrated in Table 1.

### Example 12

An intermediate carbon fiber is obtained by heating in the same manner as in Example 10 except that the angle between the axis of the furnace body and the fiber running direction is changed to 17°. At this time, the length of the fiber housed in the furnace body is 188 mm. No breakage of the fiber is found, and the processability is extremely good. The evaluation results are illustrated in Table 1.

### Comparative Example 5

The heating is performed in the same manner as in Comparative Example 4 except that the maximum electric field portion in the furnace body and the carbon fiber precursor are changed to intersect at the axis of the furnace body (that is, the configuration of FIG. 9). At this time, the length of the fiber housed in the furnace body is 55 mm. During the process, a large amount of fluff is generated on the fiber and the processability is very poor and the intermediate carbon fiber and carbon fiber cannot be obtained. The evaluation results are illustrated in Table 1.

TABLE 1

| | | | | | Fiber quality |
|---|---|---|---|---|---|
| | Fiber | Electromagnetic field at portion | | | (single filament |
| | insertion | where fiber and axis of furnace | Loading | | breakage/fluff |
| | direction | body intersect | direction | Processability | frequency) |
| Example 1 | 37° | Maximum electric field portion | H-plane | ⊚ | ⊚ |
| Example 2 | 54° | Maximum electric field portion | H-plane | ◯ | ◯ |
| Example 3 | 17° | Maximum electric field portion | H-plane | — | — |
| Comparative | 0° | Repeating of transition between | Parallel | X | X |
| example 1 | (horizontal) | maximum electric field portion | to tube | | |
| | | and maximum magnetic field | axis | | |
| | | portion | | | |
| Comparative | 90° | Maximum electric field portion | H-plane | X | X |
| example 2 | (vertical) | | | | |
| Example 4 | 37° | Maximum magnetic field portion | H-plane | ⊚ | ⊚ |
| Example 5 | 54° | Maximum magnetic field portion | H-plane | ◯ | ◯ |
| Example 6 | 17 | Maximum magnetic field portion | H-plane | — | — |
| Comparative | 90 | Maximum magnetic field portion | H-plane | — | — |
| example 3 | (vertical) | | | | |
| Example 7 | 37 | Maximum magnetic field portion | E-plane | ⊚ | ⊚ |
| Example 8 | 54 | Maximum magnetic field portion | E-plane | Δ | ◯ |
| Example 9 | 17° | Maximum magnetic field portion | E-plane | ⊚ | ⊚ |
| Comparative | 90° | Maximum magnetic field portion | E-plane | — | — |
| example 4 | (vertical) | | | | |
| Example 10 | 37° | Maximum electric field portion | E-plane | ⊚ | ⊚ |
| Example 11 | 54 | Maximum electric field portion | E-plane | Δ | ◯ |
| Example 12 | 17° | Maximum electric field portion | E-plane | ⊚ | ⊚ |
| Comparative | 90° | Maximum electric field portion | E-plane | X | X |
| example 5 | (vertical) | | | | |

### Example 13

A carbon fiber is obtained by carbonizing in the same manner as in Example 4 except that the fiber to be heated is changed from the carbon fiber precursor to an intermediate carbon fiber which is a semiconductor or a conductor. The carbon content of the obtained carbon fiber is 95% by mass, no breakage of the fiber is found, and the processability is extremely good. The evaluation results are illustrated in Table 2.

### Example 14

A carbon fiber is obtained by heating in the same manner as in Example 13 except that the angle between the axis of the furnace body and the fiber running direction is changed to 54°. The length of the fiber housed in the furnace body is 136 mm. Some single filaments are found broken, and the heating subject fiber tends to wind around the conveying roll. The evaluation results are illustrated in Table 2.

### Example 15

A carbon fiber is obtained by heating in the same manner as in Example 13 except that the angle between the axis of the furnace body and the fiber running direction is changed to 17°. The length of the fiber housed in the furnace body is 376 mm. Although some filaments are found broken during the process, the processability is good. The evaluation results are illustrated in Table 2.

### Comparative Example 6

Carbonization is performed in the same manner as in Comparative Example 1 except that the fiber to be heated is changed from the carbon fiber precursor to an intermediate carbon fiber which is a semiconductor or a conductor. During the process, the fiber is broken and the processability is very poor and the carbon fiber cannot be obtained. The evaluation results are illustrated in Table 2.

### Comparative Example 7

Carbonization is performed in the same manner as in Comparative Example 3 except that the fiber to be heated is changed from the carbon fiber precursor to an intermediate carbon fiber which is a semiconductor or a conductor. During the process, the single filament is found severed and a large amount of fluff is generated. The evaluation results are illustrated in Table 2.

### Example 16

A carbon fiber is obtained by carbonizing in the same manner as in Example 7 except that the fiber to be heated is changed from the carbon fiber precursor to an intermediate carbon fiber which is a semiconductor or a conductor. The carbon content of the obtained carbon fiber is 90% by mass, no breakage of the fiber is found, and the processability is extremely good. The evaluation results are illustrated in Table 2.

### Example 17

A carbon fiber is obtained by heating in the same manner as in Example 8 except that the fiber to be heated is changed from the carbon fiber precursor to an intermediate carbon fiber which is a semiconductor or a conductor. Some single filaments are found broken during the process, and the heating subject fiber tends to wind around the conveying roll. The evaluation results are illustrated in Table 2.

### Example 18

A carbon fiber is obtained by heating in the same manner as in Example 9 except that the fiber to be heated is changed from the carbon fiber precursor to an intermediate carbon fiber which is a semiconductor or a conductor. Although some single filaments are found broken during the process, the processability is good. The evaluation results are illustrated in Table 2.

### Comparative Example 8

Carbonization is performed in the same manner as in Comparative Example 4 except that the fiber to be heated is changed from the carbon fiber precursor to an intermediate carbon fiber which is a semiconductor or a conductor. During the process, a large amount of fluff is generated on the fiber, and the fiber tends to be wound around the conveying roll. The carbon content of the obtained carbon fiber is 90%. The evaluation results are illustrated in Table 2.

TABLE 2

| | | | | | Fiber quality |
|---|---|---|---|---|---|
| | Fiber | Electromagnetic field at portion | | | (single filament |
| | insertion | where fiber and axis of furnace | Loading | | breakage/fluff |
| | direction | body intersect | direction | Processability | frequency) |
| Example 13 | 37° | Maximum magnetic field portion | H-plane | ⊚ | ⊚ |
| Example 14 | 54° | Maximum magnetic field portion | H-plane | Δ | ◯ |
| Example 15 | 17 | Maximum magnetic field portion | H-plane | ◯ | ◯ |
| Comparative | 0° | Repeating of transition between | Parallel | X | X |
| Example 6 | (horizontal) | maximum electric field portion | to tube | | |
| | | and maximum magnetic field | axis | | |
| | | portion Loading direction | | | |
| Comparative | 90° | Maximum magnetic field portion | H-plane | Δ | Δ |
| Example 7 | (vertical) | | | | |
| Example 16 | 37° | Maximum magnetic field portion | E-plane | ⊚ | ⊚ |
| Example 17 | 54° | Maximum magnetic field portion | E-plane | Δ | ◯ |
| Example 18 | 17° | Maximum magnetic field portion | E-plane | ◯ | ◯ |
| Comparative | 90° | Maximum magnetic field portion | E-plane | Δ | Δ |
| Example 8 | (vertical) | | | | |

### REFERENCE SIGNS LIST

11 Microwave oscillator
12, 14 Connection waveguide
13 Circulator
15 Matching box
16 Iris
17, 109, 209, 309 Short-circuit plate
19 Dummy load
100, 101, 201, 301, 401, 501 Furnace body
201a, 201b H-plane of furnace body
301a, 301b E-plane of furnace body
103, 203, 303 Fiber inlet
105, 205, 305 Fiber outlet
107, 207, 307 Heat insulating tube
111, 113, 211, 213, 311, 313 Metal sleeve
150, 250, 350, 450, 550, 251, 351, 451, 551 Continuous fiber as heating subject
1000, 1000a, 1000b, 1000c, 1001, 1002, 1003, 1004 Microwave heating unit

1. A microwave heating unit comprising:
a furnace body that includes a fiber inlet and a fiber outlet which are formed on a tube wall of a waveguide; and
a microwave oscillator for introducing microwaves into the waveguide,
the continuous fiber as the heating subject being configured to run inside the waveguide with an inclination at an angle θ° with respect to a tube axis of the waveguide, the angle θ° satisfying 0<θ<90, and
the fiber outlet being formed at a portion other than a terminal end portion of the waveguide.

2. The microwave heating unit according to claim 1, wherein
the angle θ° satisfies 10<θ<60.

3. The microwave heating unit according to claim 1, wherein
the waveguide is a rectangular waveguide, and
a fiber inlet and a fiber outlet are respectively provided on a short-side tube wall of the waveguide.

4. The microwave heating unit according to claim 1, further comprising:
a heat insulating tube that penetrates the waveguide and connects the fiber inlet and the fiber outlet, wherein
the continuous fiber as the heating subject is configured to run inside the heat insulating tube.

5. The microwave heating unit according to claim 1, wherein
a material of the heat insulating tube is alumina, silica-alumina or ceramic.

6. A method for producing an intermediate carbon fiber or a carbon fiber, the method heating a continuous fiber as a heating subject while causing the continuous fiber as the heating subject to run using the microwave heating unit according to claim 1, and the method comprising a process of heating a continuous fiber as a heating subject having a carbon content of less than 66% by mass to obtain an intermediate carbon fiber or a carbon fiber.

7. The method according to claim 6, wherein
a continuous fiber as a heating subject is further heated by a maximum magnetic field portion in a waveguide while being caused to run using the microwave heating unit.

8. A method for producing an intermediate carbon fiber or a carbon fiber, the method heating a continuous fiber as a heating subject while causing the continuous fiber as the heating subject to run using the microwave heating unit according to claim 2, and the method comprising a process of heating a continuous fiber as a heating subject having a carbon content of less than 66% by mass to obtain an intermediate carbon fiber or a carbon fiber.

9. A method for producing an intermediate carbon fiber or a carbon fiber, the method heating a continuous fiber as a heating subject while causing the continuous fiber as the heating subject to run using the microwave heating unit according to claim 3, and the method comprising a process of heating a continuous fiber as a heating subject having a carbon content of less than 66% by mass to obtain an intermediate carbon fiber or a carbon fiber.

10. A method for producing an intermediate carbon fiber or a carbon fiber, the method heating a continuous fiber as a heating subject while causing the continuous fiber as the heating subject to run using the microwave heating unit according to claim 4, and the method comprising a process of heating a continuous fiber as a heating subject having a carbon content of less than 66% by mass to obtain an intermediate carbon fiber or a carbon fiber.

11. A method for producing an intermediate carbon fiber or a carbon fiber, the method heating a continuous fiber as a heating subject while causing the continuous fiber as the heating subject to run using the microwave heating unit according to claim 5, and the method comprising a process of heating a continuous fiber as a heating subject having a carbon content of less than 66% by mass to obtain an intermediate carbon fiber or a carbon fiber.

12. The method according to claim 8, wherein
a continuous fiber as a heating subject is further heated by a maximum magnetic field portion in a waveguide while being caused to run using the microwave heating unit.

13. The method according to claim 9, wherein
a continuous fiber as a heating subject is further heated by a maximum magnetic field portion in a waveguide while being caused to run using the microwave heating unit.

14. The method according to claim 10, wherein
a continuous fiber as a heating subject is further heated by a maximum magnetic field portion in a waveguide while being caused to run using the microwave heating unit.

15. The method according to claim 11, wherein
a continuous fiber as a heating subject is further heated by a maximum magnetic field portion in a waveguide while being caused to run using the microwave heating unit.
